(19) United States
(12) Patent Application Publication
(10) Pub. No.: US 2023/0283104 A1
(43) Pub. Date: Sep. 7, 2023

(54) MOBILE BRIDGE FOR GENSET CONTROLLER

(71) Applicant: ComAp a.s., Prague (CZ)

(72) Inventors: Roman Taragel, Prague (CZ); David Cermák, Prague (CZ)

(21) Appl. No.: 18/109,524

(22) Filed: Feb. 14, 2023

Related U.S. Application Data
(60) Provisional application No. 63/316,475, filed on Mar. 4, 2022.

(51) Int. Cl. H02J 13/00; H02J 3/38

(52) U.S. Cl. CPC H02J 13/00022; H02J 3/381; H02J 2300/24; H02J 2300/28

(57) ABSTRACT

An example system includes a controller configured to control operation of one or more power sources including a genset to generate power for a load. The controller is also configured to establish a communication link via a wired or wireless connection between the controller and an external computing device. The controller is also configured to receive, from the external computing device via the communication link, remote operation instructions transmitted from a remote server to the external computing device via a network. The controller is also configured to operate the genset according to the remote operation instructions of the remote server to generate the power for the load.

### CROSS-REFERENCE TO RELATED APPLICATIONS

This application claims the benefit of and priority to U.S. Provisional Patent Application No. 63/316,475 filed on Mar. 4, 2022, entitled “MOBILE BRIDGE FOR GENSET CONTROLLER,” which is incorporated herein by reference in its entirety.

### BACKGROUND

Generator sets (“gensets”) are widely used to provide electric power, especially in areas that are far from or not connected to a power grid. A genset typically includes an engine coupled to an alternator. The alternator converts rotational energy from the engine into electrical energy. A genset controller typically controls the operation of a genset, including the operation of the engine and the alternator of the genset. Over time, genset controllers evolved to improve and automate various control and monitoring capabilities. For example, a genset controller can be used to simultaneously control multiple gensets to power a shared load (e.g., a microgrid).

### SUMMARY

In an example, a system is disclosed that includes a controller configured to control operation of one or more power sources including a genset to generate power for a load. The controller is also configured to establish a communication link via a wired or wireless connection between the controller and an external computing device. The controller is also configured to receive, from the external computing device via the communication link, remote operation instructions transmitted from a remote server to the external computing device via a network. The controller is also configured to operate the genset according to the remote operation instructions of the remote server to generate the power for the load.

In an example, a computing device is disclosed that includes a communication port. The computing device is configured to communicate with a controller connected to the communication port. The computing device also includes a communication interface that includes circuitry for communicating data over a network. The computing device also includes one or more processors and an application executing on the one or more processors. The application is configured to establish a first communication link using a wired or wireless connection between the communication port and a controller. The controller is configured to operate one or more power sources including a genset to generate power for powering a load. The application is also configured to establish a second communication link between the communication interface and a remote server via the network. The application is also configured to receive remote operation instructions for operating the genset from the remote server using the second communication link. The application is also configured to transmit the remote operation instructions to the controller using the first communication link.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 is a simplified block diagram of an example system for controlling and monitoring one or more power sources, according to an example embodiment.

FIG. 2 is a schematic illustration of an example genset that can be used to implement a power source, according to an example embodiment.

FIG. 3 is a schematic illustration of an example system for remote monitoring and/or operation of a controller, according to an example embodiment.

FIG. 4 is a schematic illustration of an example implementation of a controller, according to an example embodiment.

FIG. 5 illustrates a computing device configured to implement a communication bridge between a controller and a remote server, according to an example embodiment.

FIG. 6 is a flowchart of an example process for operating a controller using remote operation instructions received via an external computing device configured as a communication bridge, according to an example embodiment.

FIG. 7 is a flowchart of an example process for operating a computing device as a communication bridge between a controller and a remote server, according to an example embodiment.

### DETAILED DESCRIPTION

Example systems, devices and methods disclosed herein may involve remote monitoring and/or control of a genset controller. In some scenarios, it may be desirable for a user to access, monitor, and/or control a genset controller remotely without being physically present at a site of the genset controller. For example, an operator of the genset controller may request support, maintenance, troubleshooting, etc., actions from an administrator or other remote user that is not currently physically present with the operator at the site of the genset controller. To facilitate this, the genset controller may be configured to provide remote access to the remote user via a network (e.g., internet, wireless network, etc.).

In an example, the genset controller may use a communication module (e.g., modem, etc.) to communicate with the network to which a remote server of the remote user is connected. In this example, the communication module may be integrated in the genset controller or implemented as an external device configured to communicatively couple with the genset controller at the site so as to provide network access to the genset controller. The use of such dedicated communication module to provide network connectivity for the genset controller may be suitable in some configurations, such as when a communication module is readily available at the site of the genset controller and/or installed within the genset controller. However, some examples may be less suitable for such dedicated communication module arrangement, such as when a communication module is not readily available or other factors (e.g., a genset controller in a remote location may need an active SIM card or other type wireless network account, etc.).

Accordingly, some example systems, devices and methods disclosed herein enable remote access to a genset controller without necessarily requiring the availability of a dedicated communication module at the physical location of the genset controller. One example method includes using an external computing device, such as a smartphone, tablet, personal computer, wireless mobile device, and/or any other type of computing device configured to access the network, as a communication bridge to establish (e.g., temporarily, etc.) an indirect communication link between the genset controller and an authorized remote server (e.g., maintenance or technical support user, etc.). For example, the external computing device may include an application executing thereon according to a predetermined protocol of the genset controller and/or the remote server to establish a first communication link with the genset controller (e.g., via a direct connection such as a USB cable or other type of local connection) and a second communication link with the remote server (e.g., via a network such as the internet). Thus, the application executing on the external computing device may be configured to facilitate transferring data and/or instructions between the genset controller (via the first link) and the remote server (via the second link). With this arrangement, in this example, remote access to the genset controller can be provided without necessarily requiring the presence and availability of a dedicated communication system (e.g., hardware, software, account, etc.) at the site of the genset controller. For example, an operator at the site may install an application (e.g., downloaded from a provider of the genset controller, etc.) onto their wireless mobile device or any other available computing device, and the application can then execute to use a wireless communication interface and/or other network connection available to the wireless mobile device (e.g., 5G network, etc.) to (at least temporarily) provide network connectivity for the genset controller. Further, this example may advantageously enable a genset controller to communicate with the external computing device using its local hardware (e.g., USB ports, bluetooth antennas, serial data ports, etc.) to indirectly communicate with the remote server over a network (e.g., Internet, etc.) accessible to the external computing device.

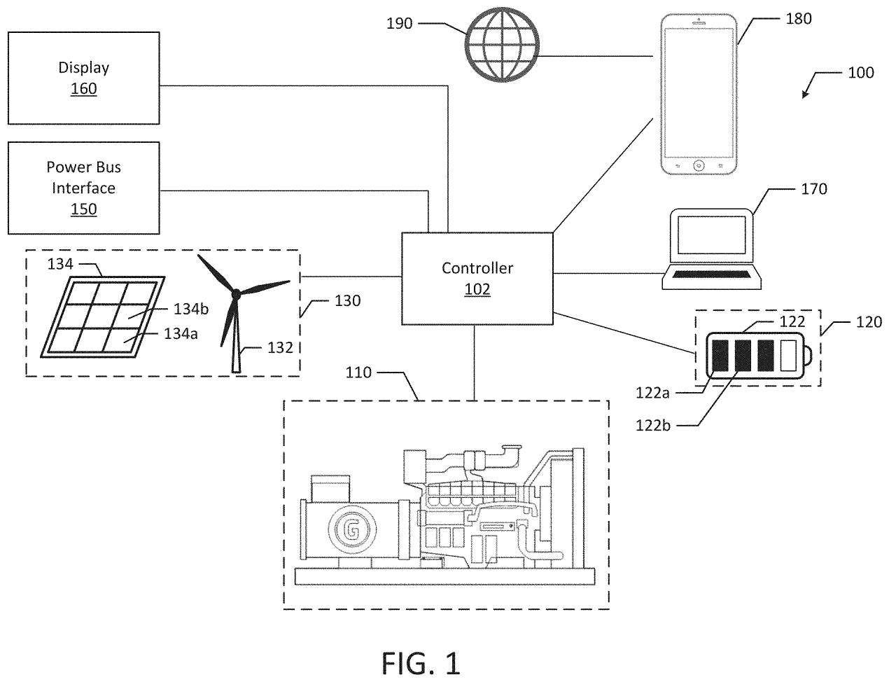

Referring now to the Figures, FIG. 1 is a simplified block diagram of an example system 100 for controlling and monitoring one or more power sources 110, 120, 130, according to an example embodiment. As shown, the system 100 includes a controller 102, a plurality of power sources 110, 120, 130, a power bus interface 150, a display 160, a computer 170, a mobile device 180, and a network 190. Data and other information can be communicated between various components of the system 100 and/or one or more other network devices connected to the network 190 (e.g., the Internet). Additionally, the data and other information may be passed to local data storage (not shown) or remote storage (not shown) over a cloud interface (not shown) accessible to the system 100 via the network 190. In alternative examples, the system 100 may include any different combination and/or any different quantity of the power sources 110, 120, and 130 than the combination and quantity shown in the illustrated example of FIG. 1. For instance, in the illustrated example of FIG. 1, the system 100 includes a single genset 110. However, in alternative examples, the system 100 may instead include more gensets or no gensets. Similarly, in some alternative examples, the system 100 may include fewer or more of any of the power sources 120 and 130.

In some examples, the controller 102 may be installed at a facility in a control room near one or more of the power sources 110, 120, 130. In some examples, one or more of the power sources 110, 120, 130 may include various sensors in communication with the controller 102. In some examples, the controller 102 can be implemented using any combination of hardware components, software components, digital circuitry, and/or analog circuitry wired and/or otherwise configured to perform the functions of the controller 102 described in the present disclosure. For example, the controller 102 may include a processor (not shown) configured to execute program instructions stored in a non-transitory computer readable medium (not shown) to cause the system 100 to operate in accordance with the present disclosure. In the illustrated example of FIG. 1, the controller 102 is shown to include a single controller. In alternative examples, the controller 102 is physically implemented as multiple separate controllers in communication with one another and/or with one or more other components of the system 100. More generally, in some examples, the on-site controller 102 may include or may be connected to other devices and other controllers, breakers, communication bridges, etc. that can provide additional monitoring and/or control capabilities.

The power source 110 may also be referred to herein as a genset 100. In some examples, as noted above, the genset 110 may include an engine (e.g., diesel engine, gas engine, etc.) that actuates an alternator to generate AC power or DC power at an output of the alternator.

The power source 120 may also be referred to herein as a power storage system 120. In the illustrated example of FIG. 1, power source 120 includes one or more batteries 122. The battery 122 includes one or more power cells, exemplified by power cells 122a and 122b, that are configured to convert chemical energy (e.g., hydrogen fuel, other fuel, etc.) into electrical energy at electrodes (not shown) of the power cells 122a and 122b. A non-exhaustive list of example power cells 122a, 122b includes: hydrogen fuel cells, electrochemical cells, and/or galvanic cells, among other examples.

The power sources 130 may also be referred to herein as renewable energy systems 130. As shown, the renewable energy systems 130 include a wind turbine power generation system 132 and a solar power system 134. The solar power system 134 includes one or more solar cells, exemplified by solar cells 134a an 134b, which may include any types of photovoltaic cells or other power cells that convert solar energy (e.g., light) into electrical energy output at electrodes (not shown) of the solar cells 134a and 134b.

The power bus interface 150 includes one or more electrical components (e.g., load contactors, circuit breakers, wiring, etc.) used to connect one or more of the power sources 110, 120, 132, 134, and/or an external power grid (not shown), such as a microgrid for example, in parallel to a power bus (not shown) that provides power from any of the connected resources to a shared load. It is noted that although the power bus interface 150 is shown in FIG. 1 as a single component, in some examples, the power bus interface 150 (and/or one or more components thereof) may alternatively be physically implemented within one or more other components (e.g., the controller 102, the inverter system 140, etc.) of the system 100.

The display 160 may include any type of display (e.g., liquid crystal display (LCD), light emitting diode (LED) display, touch screen, etc.) configured to present outputs from the controller 102 (e.g., measurements of sensors in any of the power sources 110, 120, 130, etc.) and/or to provide a user interface of the controller 102 to an operator (e.g., technician, etc.) of the system 100 so that the operator can interact with the controller 102 and/or other components of the system 100.

Similarly, the computer 170 and/or the mobile device 180 can be used to provide data and other information to a user of the system 100, or to provide a user interface to the user for monitoring and/or inputting operation parameter for operating one or more components of the system 100 (e.g., the power sources 110, 120, 130, the inverter system 140, the power bus interface 150, etc.).

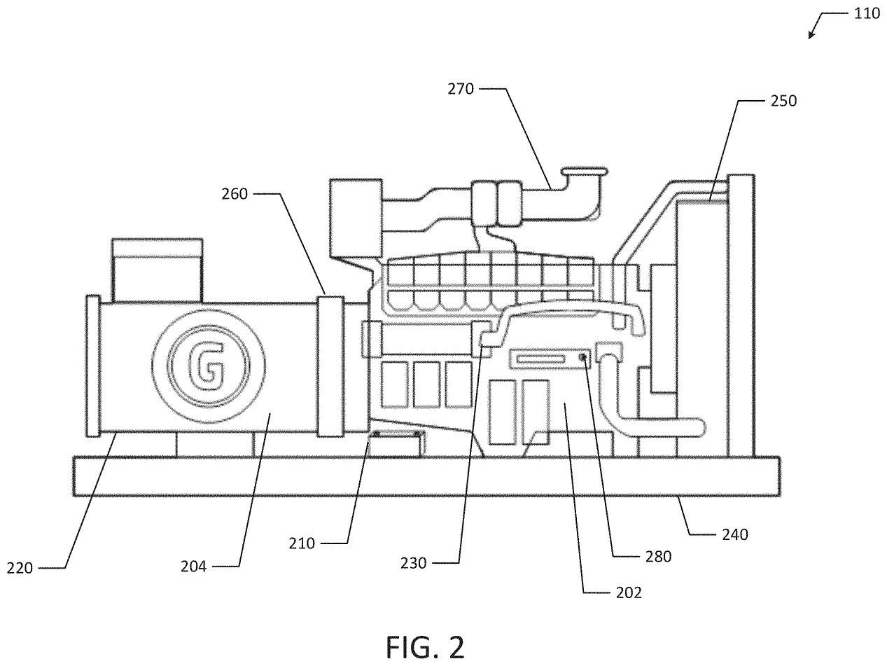

FIG. 2 illustrates an example implementation of the genset 110 of FIG. 1. In the illustrated example of FIG. 2, the genset 110 includes an engine 202 and an alternator 204. The engine 202 may include any type of engine that generates mechanical energy from by consuming a fuel, such as a combustion engine (e.g., diesel engine, gas engine, etc.) or any other type of engine. The mechanical energy from the engine 202 is then transformed into electrical energy by the alternator 204 that is outputted by the alternator 204 as AC power. In the illustrated example of FIG. 2, the genset 110 also includes a plurality of sensors such as a battery monitor 210, an alternator winding temperature sensor 220, a lube oil quality monitor 230, a structural vibration sensor 240, a coolant temperature sensor 250, a bearing failure sensor 260, an exhaust temperature sensor 270, and a lube oil pressure sensor 280, etc. In some examples, the genset 110 may alternatively or additionally include other sensors such as an ambient temperature sensor, a throttle position sensor, an air filter pressure sensor, and a gas flow sensor. Outputs of the various sensors of the genset 110 (as well as other sensors of the other power sources 120, 130) can be monitored by the controller 102 of FIG. 1 to facilitate optimizing the performance of the various power sources and/or detecting failures or other potential faults in the power sources.

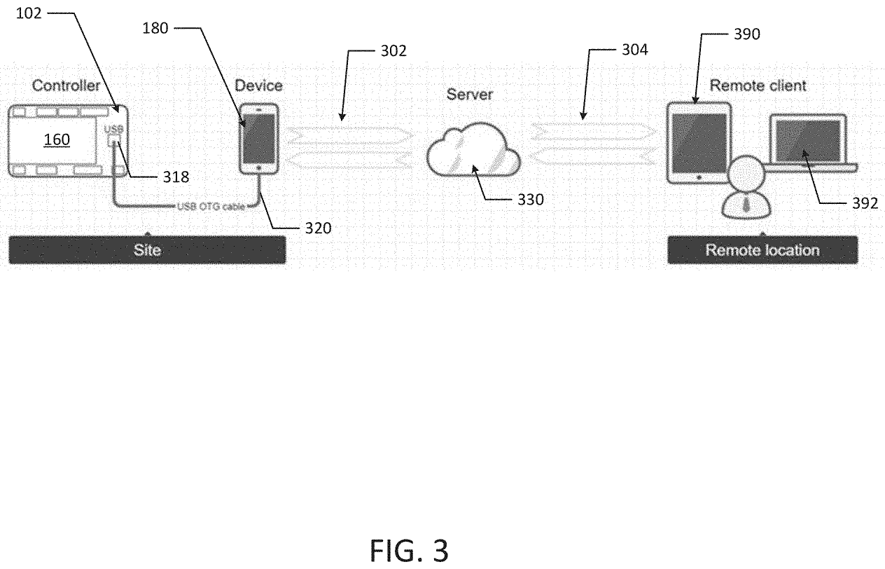

FIG. 3 illustrates an example implementation of the system 100 of FIG. 1, in which the mobile device 180 (e.g., external computing device) is configured as a communication bridge for remote access to the controller 102 via a network (e.g., network 190 of FIG. 1). It is noted that some of the components of the system 100 (e.g., power sources 110, 120, 130, etc.) are omitted from the illustration of FIG. 3 for convenience in description.

In the illustrated example of FIG. 3, the controller 102 includes the display 160 implemented as a component of the controller 102. Further, the controller 102 may include a communication port 318. The communication port 318 may be used by the controller 102 to establish a direct communication link with an external computing device (e.g., mobile device 180). In an example, the communication link is via a wired connection (e.g., using a cable 320) between the communication port 318 and the device 180. For instance, the communication port 318 may be a USB that receives an end of the cable 320 (e.g., USB cable, USB on-the-go (OTG) cable, etc.). In other examples, the controller 102 may establish the communication link with the mobile device 180 (e.g., located in the same site as the controller 102) using a different types of hardware and/or circuitry. To that end, the controller 102 may include any combination of hardware or software wired and/or configured to facilitate communication between the controller 102 and the device 180.

The device 180 may be configured as a communication and/or bus gateway, that transmits messages, communications, and/or instructions from or to the controller 102 and a remote server 330 according to a communications protocol (e.g., control area network (CAN) bus, ModBus, transfer control protocol (TCP), manufacturer-specific communication protocol, etc.) of the controller 102 and the server 330. In an example, the device 180 may be configured to transform control instructions from a first format (e.g., encrypted, TCP, etc.) of the server 330 to a second format (e.g., analog, ModBus, binary, CAN bus, etc.) of the controller 102 before transmitting the transformed control instructions received from the server 330 (e.g., via a communication link 302) to the controller 102 (e.g., via communication link 320). The device 180 may also include other types of hardware or software components (e.g., cellular communication module, Ethernet communication module, and/or a wireless communication module such as a WiFi communication module, 5G data communication module, etc.) to facilitate communication between the controller 102 and the remote server 330. In an example, the device 180 is configured to establish the communication link 302 with the remote server 330 via a data communication network, such as the network 190 of FIG. 1, the Internet, a mobile data network (e.g., 5G, etc.), or any other type of network.

The remote server 330 may include any type of remote computing server configured to establish the communication link 302 with the device 180 (e.g., authenticated or secure link, etc.). For example, the device 180 may include an application configured to use a secure communication protocol of a manufacturer or provider or administrator of the controller 102 and/or the remote server 330.

The example implementation of the system 100 illustrated in FIG. 3 may also include one or more remote client devices 390, 392 (e.g., computers, tablets, smartphones, etc.) at a remote location from the site of the controller 102. The configured to access the controller 102 remotely via the remote server 330 and the device 180. For example, the remote client devices 390, 392 may be operated by authenticated users (e.g., technical support specialists, etc.) authorized to access the controller 102 via the server 330 by establishing a communication link 304 with the remote server 330. To that end, similarly to the link 302, the communication link 304 may include a wired and/or wireless connection with the server 330 via a network (e.g., network 190), such as the Internet.

Thus, the system 100 according to the example implementation of FIG. 3 may be configured to allow the remote server 330, the client device 390, and/or the client device 392 to access the controller 102 remotely via a network (e.g., 190) that is indirectly accessible to the controller 102 (at least temporarily) via the mobile device 180.

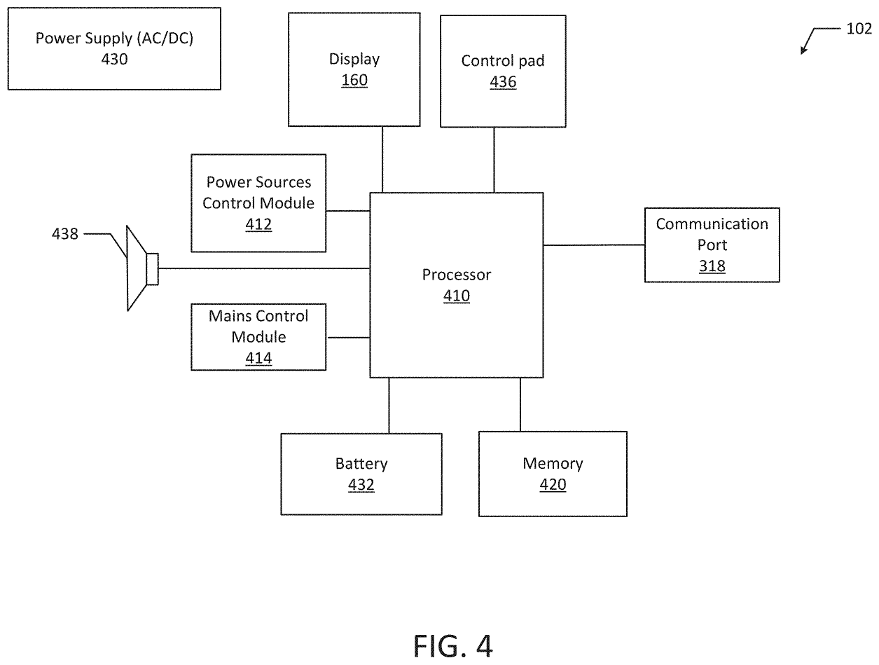

FIG. 4 illustrates a schematic view of an example implementation of the controller 102. As illustrated in the example of FIG. 4, the controller 102 may also include a processor 410, a memory 420, a power supply 430, a battery 432, a control pad 436, speakers 438, and a power sources control module 412. It is noted that the various blocks illustrated in FIG. 3 can be implemented using fewer or more physical components. In an example, one or more of the modules 412, and/or 414 can be physically implemented as separate devices (e.g., each module implemented as a separate controller that include a processor and a memory, etc.). In an alternative example, the functions of one or more of these modules can be physically implemented by a single controller. Other implementations are possible as well.

The processor 410 includes one or more processors configured to executed program instructions (not shown) stored in the memory 420 to cause the controller 102 to perform the various functions of the controller described in the present disclosure. To that end, the memory 420 may include any type of memory (e.g., volatile or non-volatile) suitable for the processor 410. For example, the program instructions executable by the processor 410 may be stored in a non-transitory computer readable medium of the memory 420. In some examples, one or more of the functions described for the power sources module 412 and/or the mains control module 414 can be implemented as program instructions stored in the memory 420 and executable by the processor 410. In alternative examples, the modules 412, 414, etc. can be implemented using separate physical devices (e.g., hardware components, software components, analog or digital circuitry, etc.) wired to perform the respective functions of these various components. In some examples, the processor 410 is configured to receive remote operation instructions (e.g., transmitted from the remote server 330 of FIG. 3) received from an external computing device (e.g., the device 180 of FIG. 3) via the communication port 318, and to operate the power sources module 412, the mains control module 414, the power sources 110-130, and/or any other component of the system 100 controlled by the controller 102 according to the received remote operation instructions.

The power sources control module 412 may be configured to generate control signals for controlling the power sources 110, 120, and/or 130 (shown in FIG. 1), as well as process, monitor, and/or control sensor measurements received from sensors of any of the power sources, control process outputs displayed in the display 160, and/or inputs received from an operator via a user interface of the controller 102 (e.g., the display 160, a control pad 436, etc.). In some examples, the module 412 and/or the module 414 also selectively connects one or more of the power sources 110, 120, and/or 130 to a power bus (e.g., power bus 150) so that the connected power source(s) can power a load (not shown) via the power bus. The mains control module 414 may be configured as a protection or supervision controller that facilitates selectively connecting an external power grid (e.g., mains grid, utility grid, etc.) to the power bus 150 and/or power outputs of any of the power sources 110, 120, and/or 130. For example, the module 414 can operate one or more switches, load contactors, and/or circuit breakers to selectively connect or disconnect the external power grid to any of the power sources (connected to the power bus interface 150).

The battery 432 and the power supply 430 can be configured to provide power for the various components of the controller 102.

The speakers 438 may emit audible signals to indicate when an alarm condition is present or when a failure event is predicted and/or present, to provide audible instructions to a technician/operator, or to indicate a selection on the control pad 436.

In an example, a technician (e.g., human operator) physically located at a site of the controller 102 may monitor operation outputs, control operational parameters of the power sources (e.g., genset 110, solar cells 134, wind turbine 132, battery 122, etc.), edit set points, start or stop the one or more power sources, configure inputs and outputs, access and review alarm information and other event history information through the controller 102. For example, a technician may monitor fuel levels, voltages, alternator/inverter parameters, lube oil, vibrations, bearings, temperatures, alternator or inverter rotation speeds, power outputs, etc. from various monitors, sensors and gauges of any of the power sources 110, 120, and/or 130 while on-site at a facility of the system 100 using the controller 102. For example, controller 102 can be used to send control instructions and apply genset operating configurations to the genset 110. Additionally, the controller 102 can be used to send control instructions to, apply, and/or monitor operation conditions of, any of the power sources 110, 120, and/or 130 of FIG. 1.

In an example, one or more of the capabilities described above may additionally or alternatively be provided for a technician at a remote location. For example, the controller 102 may be configured to communicate with a client device (e.g., devices 390, 392, etc. of FIG. 3) via an external computing device (e.g., mobile device 180 of FIG. 3) at the site of the controller 102 that is connected to the controller 102 via the communication port 318.

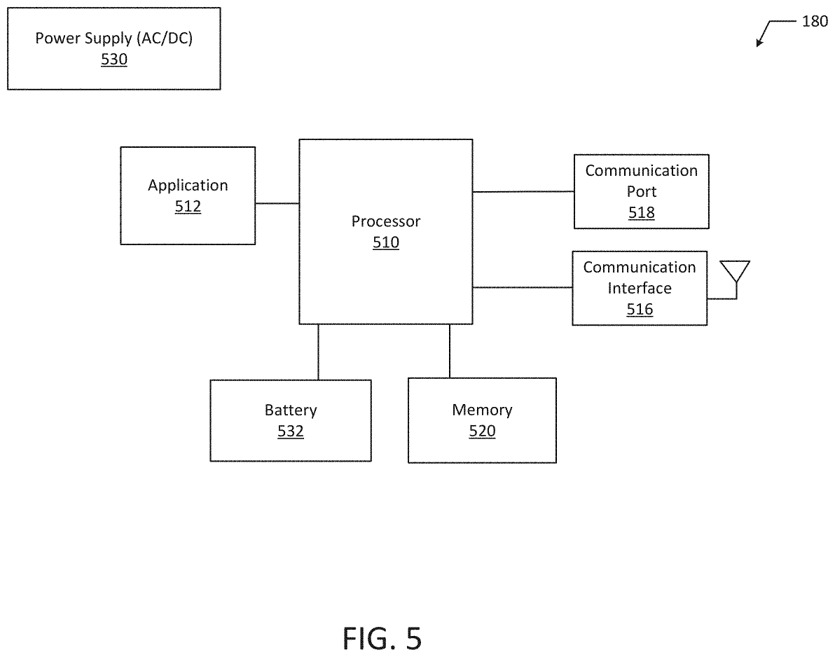

FIG. 5 is a schematic illustration of an example implementation of the external computing device 180, according to an example embodiment. As shown in the illustrated example of FIG. 5, the computing device 180 may include one or more processors 510, a memory 520, a power supply 530, a battery 532, and a communication port 518 which may be similar, respectively, to the processor(s) 410, the memory 420, the power supply 430, the battery 432, and the communication port 318 of the controller 102. For example, the memory 520 may store program instructions executable by the processor 510 to control the various components of the device 180 and/or cause the device 180 to perform the various functions described herein. Further, the battery 532 may provide power to the various components of the device 180. Further, the communication port 518 may include any type of wired or wireless communication circuitry (e.g., USB port, etc.) configured to receive and/or establish a direct wired or wireless connection with the controller 102 (e.g., via the cable 320 of FIG. 3, etc.). Further, for example, the power supply 430 may provide an alternative energy source for the processor 510, the communication port 518, the communication interface 516, etc., as well as to charge the battery 532.

In the illustrated example of FIG. 5, the computing device 180 may also include an application 512 and a communication interface 516. The application 512 may be executed on the one or more processors 510 to cause the device 180 to perform one or more of the functions described herein. The communication interface 516 may include any combination of circuitry, hardware, and/or software components wired to enable the device 180 to connect with an external network (e.g., network 190), such as the Internet or any other data communication network. In an example, the communication interface 516 may be a wireless communication interface that includes an antenna, a modem, and/or any other circuitry configured to connect to the network 190 using a wireless communication protocol (e.g., mobile data communication network, 5G data communication network, etc.). In other examples, the communication interface 516 may alternatively or additionally include circuitry configured to connect with the network 190 using a wired connection (e.g., Ethernet, etc.) and/or any other type of data communication protocol (e.g., TCP, etc.).

In an example, the application 512, upon execution on the processor(s) 510, is configured to establish a first communication link with the controller 102 (e.g., via the communication ports 318, 518, the cable 320, etc.), and a second communication link (e.g., communication link 302 of FIG. 3) with a remote server (e.g., remote server 330). Further, the application 512 may be configured to operate the device 180 as a communication bridge between the controller 102 and the remote server 330. For example, the application 512 may be configured to cause the device 180 to communicate (e.g., using a predetermined communication protocol, a manufacturer-specific protocol, or any other communication protocol) remote operation instructions, received from the remote server 330 via the communication link 302, to the controller 102 via the communication port 518. As another example, the application 512 may be configured to cause the device 180 to communicate data (e.g., sensor measurements collected at the genset 110, etc.), received from the controller 102 via the communication ports 318 and 518, to the remote server 330 via the network 190 and the communication interface 516, in accordance with the present disclosure.

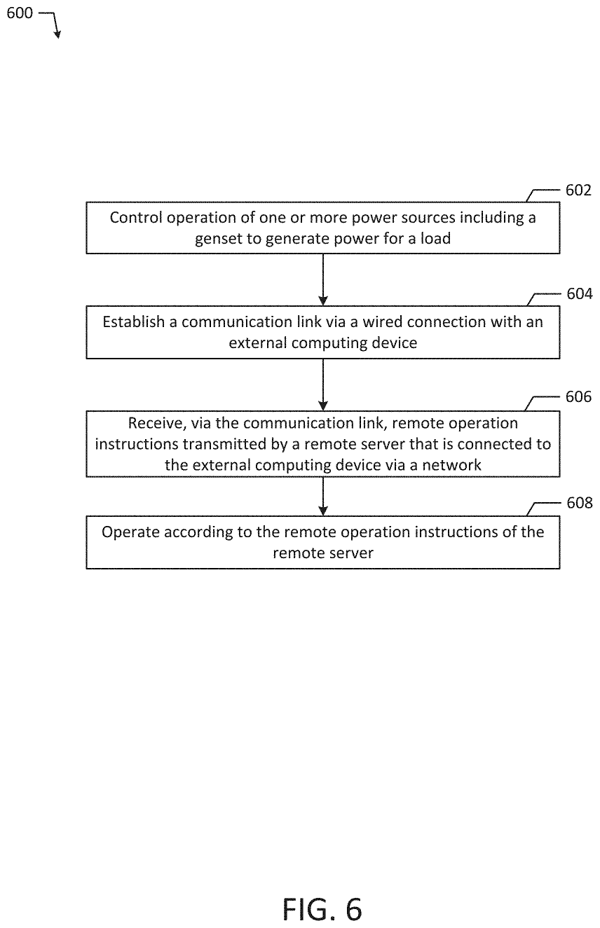

FIG. 6 is a flowchart of an example method 600 for operating a genset controller (e.g., controller 102 of FIG. 1) according to remote operation instructions received from a remote server (e.g., 330) that is indirectly accessible to the controller via an external computing device (e.g., device 180), according to an example embodiment. Although the example method 600 is described with reference to the flowchart illustrated in FIG. 6, it will be appreciated that many other methods of performing the acts associated with the method 600 may be used. For example, the order of some of the blocks may be changed, certain blocks may be combined with other blocks, and some of the blocks described are optional. The method 600 may be performed by processing logic that may comprise hardware (circuitry, dedicated logic, etc.), software, or a combination of both.

At block 602, method 600 involves controlling operation of one or more power sources including a genset to generate power for a load. Referring back to FIG. 1 for example, the controller 102 may be configured to adjust or monitor or control operation parameters of the genset 110 and/or any of the power sources 120, 130 so as to provide power output from the power sources 110, 120, and/or 130 to the power bus interface 150 for powering a load (e.g., microgrid, etc.) connected to the system 100 via the power bus interface 150.

At block 604, method 600 involves establishing a communication link via a wired connection with an external computing device. Referring back to FIG. 3 for example, the controller 102 may establish the communication link with the external computing device 180 via a wired connection using the communication port 318 (e.g., USB port, etc.) and the cable 320 (e.g., USB cable, etc.) and/or via a wireless connection (e.g., Bluetooth connection, etc.).

At block 606, method 600 involves receiving, via the communication link, remote operation instructions transmitted by a remote server that is connected to the external computing device via a network. Referring back to FIG. 3 for example, the device 180 may receive the remote operation instructions from the remote server 330 by establishing the communication link 302 with the remote server 330 using the network 190 (shown in FIG. 1). The device 180 may then transmit the remote operation instructions to the controller 102 (e.g., via the cable 320). In turn, the controller 102 at block 606 may receive the remote operation instructions of the remote server 330 (indirectly) from the external computing device 180 via the communication link established with the device 180 using the communication port 318.

At block 608, method 600 involves operating according to the remote operation instructions of the remote server. Referring back to FIGS. 1-2 for example, depending on the remote operation instructions, the controller 102 may monitor sensor measurements collected at the genset 110, monitor/apply operation parameters (e.g., fuel combustion rate, etc.) to the genset 110, and/or control operation of the genset 110 and the power bus interface 150 to generate power for a load connected to the system 100, among other possibilities.

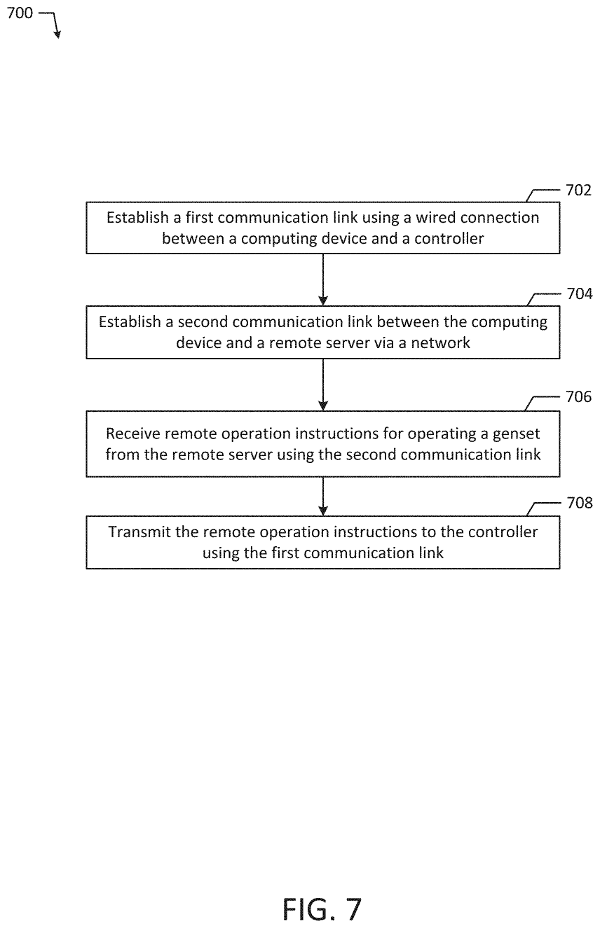

FIG. 7 is a flowchart of an example method 700 for operating a computing device (e.g., device 180) as a communication bridge for a remote server (e.g., remote server 330) to remotely operate a controller (e.g., controller 102), according to an example embodiment. Although the example method 700 is described with reference to the flowchart illustrated in FIG. 7, it will be appreciated that many other methods of performing the acts associated with the method 700 may be used. For example, the order of some of the blocks may be changed, certain blocks may be combined with other blocks, and some of the blocks described are optional. The method 700 may be performed by processing logic that may comprise hardware (circuitry, dedicated logic, etc.), software, or a combination of both.

At block 702, method 700 involves establishing a first communication link using a wired connection between a computing device and a controller. Referring back to FIG. 3 for example, the computing device 180 may establish the first communication link to the controller 102 using the wired connection defined by the cable 320.

At block 704, method 700 involves establishing a second communication link between the computing device and a remote server via a network. Referring back to FIG. 3 for example, the computing device 180 may establish the second communication link 302 over the network (e.g., network 190 of FIG. 1) to the remote server 330. In an example, the computing device 180 may be a wireless mobile device (e.g., smartphone, tablet, etc.) that connects to the network (e.g., internet) wirelessly.

In an example, the method 700 may also involve executing an application (e.g., application 512 of FIG. 5) to establish the first and second communication links according to a particular communication protocol of the controller and the remote server (e.g., a proprietary or manufacturer-specific protocol which the application 512, the controller 102, and/or the remote server 330 are programmed to use, etc.).

At block 706, method 700 involves receiving remote operation instructions for operating a genset from the remote server using the second communication link. Referring back to FIG. 3 for example, the computing device 180 may receive the remote operation instructions (e.g., originating from a remote user at the client devices 390, 392, etc.) from the remote server 330 using the communication link 302.

At block 708, method 700 involves transmitting the remote operation instructions to the controller using the first communication link. Referring back to FIG. 3 for example, the computing device 180 can use the cable 320 (e.g., the first communication link) to transmit the remote operation instructions (e.g., instructions from a remote technician, etc.) to the controller 102.

In some examples, processors described herein such as processor 410 of FIG. 4 and/or processor 510 of FIG. 5 may include any device capable of executing instructions encoding arithmetic, logical, and/or I/O operations. In one example, the processors 410 and/or 510 may use a Von Neumann architectural model and may include an arithmetic logic unit (“ALU”), a control unit, and a plurality of registers. In some examples, the processors 410 and/or 510 may include a single core processor which is typically capable of executing one instruction at a time (or process a single pipeline of instructions), or a multi-core processor which may simultaneously execute multiple instructions. In some examples, the processor 410 and/or 510 may be implemented as a single integrated circuit, two or more integrated circuits, or may be a component of a multi-chip module (e.g., in which individual microprocessor dies are included in a single integrated circuit package and hence share a single socket). In some examples, the processor 410 and/or 510 may be referred to as a central processing unit (“CPU”). Additionally, in some examples, the processor 410 and/or 510 may be a microprocessor, a microcontroller, or a microcontroller unit (“MCU”).

As discussed herein, a memory device or memory 420 and/or 520 refers to a volatile or non-volatile memory device, such as random access memory (“RAM”), read-only memory (“ROM”), electrically erasable programmable read-only memory (“EEPROM”), or any other device capable of storing data. The processors 410, 510, and/or the memory 420, 520 may be interconnected using a variety of techniques, ranging from a point-to-point processor interconnect, to a system area network, such as an Ethernet-based network.

Aspects of the subject matter described herein may be useful alone or in combination with one or more other aspects described herein.

In a first exemplary aspect of the present disclosure, a system is disclosed that includes a controller configured to control operation of one or more power sources including a genset to generate power for a load. The controller is also configured to establish a communication link via a wired or wireless connection between the controller and an external computing device. The controller is also configured to receive, from the external computing device via the communication link, remote operation instructions transmitted from a remote server to the external computing device via a network. The controller is also configured to operate the genset according to the remote operation instructions of the remote server to generate the power for the load.

In accordance with a second exemplary aspect of the present disclosure, which may be used in combination with any one or more of the preceding aspects, the external computing device is wirelessly connected to the remote server via a wireless communication interface of the external computing device.

In accordance with a third exemplary aspect of the present disclosure, which may be used in combination with any one or more of the preceding aspects, the external computing device is configured as a communication bridge for transferring communications between the controller and the remote server via the network according to a secure communication protocol of the controller and the remote server.

In accordance with a fourth exemplary aspect of the present disclosure, which may be used in combination with any one or more of the preceding aspects, the controller includes a universal serial bus (USB) port, and the wired connection is between the USB port and the external computing device.

In accordance with a fifth exemplary aspect of the present disclosure, which may be used in combination with any one or more of the preceding aspects, the external computing device is a wireless mobile device.

In a sixth exemplary aspect of the present disclosure, a computing device is disclosed that includes a communication port. The computing device is configured to communicate with a controller connected to the communication port. The computing device also includes a communication interface that includes circuitry for communicating data over a network. The computing device also includes one or more processors and an application executing on the one or more processors. The application configured to establish a first communication link using a wired or wireless connection between the communication port and a controller. The controller is configured to operate one or more power sources including a genset to generate power for powering a load. The application is also configured to establish a second communication link between the communication interface and a remote server via the network. The application is also configured to receive remote operation instructions for operating the genset from the remote server using the second communication link. The application is also configured to transmit the remote operation instructions to the controller using the first communication link.

In accordance with a seventh exemplary aspect of the present disclosure, which may be used in combination with any one or more of the preceding aspects, the communication port is a Universal Serial Bus (USB) port.

In accordance with an eighth exemplary aspect of the present disclosure, which may be used in combination with any one or more of the preceding aspects, the communication interface is a wireless communication interface. The second communication link includes a wireless link between the wireless communication interface and the network.

In accordance with a ninth exemplary aspect of the present disclosure, which may be used in combination with any one or more of the preceding aspects, the application is configured to establish the first and second communication links based on a secure communication protocol of the controller and the remote server.

In accordance with a tenth exemplary aspect of the present disclosure, which may be used in combination with any one or more of the preceding aspects, the computing device is a wireless mobile device.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A system comprising:
a controller configured to:
control operation of one or more power sources including a genset to generate power for a load;
establish a communication link via a wired or wireless connection between the controller and an external computing device;
receive, from the external computing device via the communication link, remote operation instructions transmitted from a remote server to the external computing device via a network; and
operate the genset according to the remote operation instructions of the remote server to generate the power for the load.

2. The system of claim 1, wherein the external computing device is wirelessly connected to the remote server via a wireless communication interface of the external computing device.

3. The system of claim 1, wherein the external computing device is configured as a communication bridge for transferring communications between the controller and the remote server via the network according to a secure communication protocol of the controller and the remote server.

4. The system of claim 1, wherein the controller includes a universal serial bus (USB) port, and wherein the wired connection is between the USB port and the external computing device.

5. The system of claim 1, wherein the external computing device is a wireless mobile device.

6. A computing device comprising:
a communication port, wherein the computing device is configured to communicate with a controller connected to the communication port;
a communication interface that includes circuitry for communicating data over a network;
one or more processors; and
an application executing on the one or more processors, the application configured to:
establish a first communication link using a wired or wireless connection between the communication port and a controller, wherein the controller is configured to operate one or more power sources including a genset to generate power for powering a load;
establish a second communication link between the communication interface and a remote server via the network;
receive remote operation instructions for operating the genset from the remote server using the second communication link; and
transmit the remote operation instructions to the controller using the first communication link.

7. The computing device of claim 6, wherein the communication port is a Universal Serial Bus (USB) port.

8. The computing device of claim 6, wherein the second communication link includes a wireless link between the wireless communication interface and the network.

9. The computing device of claim 6, wherein the application is configured to establish the first and second communication links based on a secure communication protocol of the controller and the remote server.

10. The computing device of claim 6, wherein the computing device is a wireless mobile device.

11. The computing device of claim 6, wherein the computing device is configured to communicate with the controller using a cable.

12. The computing device of claim 6, wherein the computing device is configured to communicate with the controller wirelessly.

13. The computing device of claim 6, wherein the application is further configured to:
receive data from the controller; and
transmit the received data to the remote server.
